(19) United States
(12) Patent Application Publication
(10) Pub. No.: US 2012/0180884 A1
(43) Pub. Date: Jul. 19, 2012

(54) Interconnection of Microfluidic Devices

(75) Inventors: Pierre Brunello, Villecerf (FR); Willard Ashton Cutler, Elmira, NY (US); Paul Louis Florent Delautre, Lisses (FR); Sylvain Maxime F. Gremetz, Montereau Fault Yonne (FR); Ionel Lazer, Marolles En Brie (FR); Olivier Lobet, Mennecy (FR)

(73) Assignee: CORNING INCORPORATED

(21) Appl. No.: 13/499,447

(22) PCT Filed: Oct. 7, 2010
(86) PCT No.: PCT/US2010/051806

§ 371 Date: Mar. 30, 2012

(30) Foreign Application Priority Data
Oct. 9, 2009 (FR) 0957079

(51) Int. Cl. F15B 21/00; B01L 3/00

(52) U.S. Cl. 137/561 R; 422/503

(57) ABSTRACT

A microfluidic device (10) includes at least two glass, ceramic or glass ceramic microfluidic modules (20) fluidicaly interconnected and of substantially plate shape defining generally four relatively thin edges (20a, 20b, 20c, 20d) and two opposite relatively large faces (22, 24), each microfluidic module (20) including at least one microfluidic channel (30) defining at least in part a microchamber (32); at least one fluidic inlet (50) and at least one fluidic outlet (60); and said microfluidic modules being tightly interconnected with a fluid duct (120) through at least one tightly holding connector (90) comprising at least one clamping structure or means (95, 97), and is characterized in that the at least one clamping means (95, 97) comprises a joint (150) comprising a spherical shaped member (160) and a cup shaped member (170).

This application claims the benefit of priority under 35 USC 119(e) of French priority application 0957079 filed Oct. 9, 2009.

### BACKGROUND

The disclosure relates to a micro fluidic device.

Various methods and structures have been proposed for use in mounting and connection of/or interconnecting microfluidic devices, including glass, glass-ceramic and ceramic microfluidic devices. Existing methods include the stacking of microfluidic modules directly against each other with seals or couplers positioned between, fixing a metal or a polymer fluid coupler to the device by an adhesive or the like and pressing a multiple-port connector with multiple compression seals up against the modules to form the microfluidic device.

These microfluidic devices can be used for chemical reaction, sample processing, analysis and collection. With regard to chemical reactions, these microfluidic devices are named micro-reactors. An example of prior art reference is EP-1,679,115. This document describes a high performance micro-reactor with a design of a multi-layer, composed of one reaction layer where two reactants can be mixed and two heat exchange layers, sandwiching the reaction layer, are dedicated to ensure good heat management.

A glass microfluidic module is drilled on back and front faces to ensure reactants inlets and product outlet but also inlet and outlet of thermal fluid used to ensure thermal control of micro-reactor, circulating into heat exchange layers.

It is also described in EP-1,854,543 A1, a specific connection system used to ensure interconnection between glass fluidic modules and with end-user systems.

U.S. Pat. No. 6,450,047 B2 discloses a device for high throughput sample processing, analysis, and collection, and methods of use thereof.

Further, WO 02/064247=EP-1,360,000 discloses a device for connecting microcomponents, especially micro-reactors, preferably configured in a form of a plate and preferably made of silicon. A sealing plate is arranged between the microcomponents provided with openings which correspond to openings of the microcomponents.

A microfluidic device and a method of manufacture thereof is also disclosed in a previous Applicants' patent application US 2003/0,192,587 A1.

It would be desirable to enable use of methods of manufacture of lower cost with less constraints on the flatness of glass, ceramic or vitro-ceramic pieces for microfluidic modules of substantially plate shape. It would also be desirable to allow for volume scalability, increased treatment volume, reduced pressure drop within the treatment circuit, by allowing for stacking of several glass microfluidic modules while providing a reliable tightness between the stacked modules.

It would also be desirable to improve the compactness of several glass microfluidic modules to be used together, and of reducing the number of connections and fittings to limit the potential leakage points.

It would also be desirable to provide these advantages with a solution which is simple, reliable, not increasing the costs over the prior art processes or even reducing the costs of manufacture, thereby enabling a production at the industrial scale.

Finally, it would also be desirable to provide a solution that allows for any type of treatment which would be made in the microfluidic device, let it be chemical reactions, sampling, analysis, etc.

### SUMMARY

According to a first aspect of this disclosure, a microfluidic device includes at least one glass, ceramic or glass ceramic, microfluidic module of substantially plate shape defining generally four relatively thin edges and two opposite relatively large faces, each microfluidic module including at least one microfluidic channel defining at least in part a microchamber; at least one fluidic inlet and at least one fluidic outlet; and each microfluidic inlet and each microfluidic outlet of said microfluidic module are tightly interconnected with a fluid duct through a tightly holding connector comprising at least one, in particular at least one set of paired, clamping structure(s) or clamping means, wherein said at least one clamping means comprises a joint comprising a spherical shaped member and a cup shaped member. In other words, the joint is of the type “ball and socket” joint.

According to second embodiment, the microfluidic device is further characterized in that said at least one clamping means is provided with a radial retaining structure or anti-radial deformation means.

According to a specific feature, the anti-radial deformation means comprises at least one metallic ring.

According to another specific feature, the spherical shaped member is conformed to receive and support said anti-radial deformation means.

According to a third embodiment, the microfluidic device comprises at least two stacked microfluidic modules defining at least a set of two successive microfluidic modules tightly interconnected with a fluid duct through at least one holding connector comprising a C-clamp defining a first lateral arm with a first clamping means, a second lateral arm with a second clamping means and a main connecting part.

The microfluidic module could also be manufactured in a metal or an alloy.

According to particular feature, at least one of said first and second lateral arms is movable into translation relatively to said main connecting part.

According to an yet another feature, said micro fluidic device further includes between two successive microfluidic modules, an intermediate sealing connecting plate provided with through openings adapted to match with adjacent fluidic inlets and adjacent fluidic outlets, said connecting plate further comprising sealing structures or sealing means on said through openings.

According to another particular feature, at least one fluid port or means for injecting or extracting at least one fluid at an appropriate location of the stack is provided, for example, on at least one lateral edge of an intermediate sealing connecting plate for injection of at least one further fluid reactant (R) in communication with the treatment micro chamber, or for extracting a part of the fluid.

According to a further particular feature, the microfluidic modules have aligned and opposed inlets and outlets.

According to another particular feature, the microfluidic modules have a connection pattern wherein the inlets and outlets are opposed and offset, thereby having also corresponding offset opposed inlets and outlets of the intermediate sealing connecting plates.

According to a particular embodiment, the microfluidic modules comprise specific layers for thermal exchange each on an opposing side of the treatment layer from the other, sandwiching the treatment layer between, each microfluidic module being provided with 2 opposite thermal fluid inlets and two opposite thermal fluid outlets, whereas the treatment layer is provided with at least one fluid feed inlet and at least one fluid feed outlet.

According to another particular embodiment patentable per se, said intermediate connecting plate comprises, on at least one of said edges, a first alignment structure or first aligning means adapted to cooperate with a second alignment structure or second aligning means provided on a corresponding edge of said holding connector thereby ensuring easy proper alignment of said microfluidic modules.

According to another particular feature, connecting parts comprising the “ball and socket” joint, as well as the intermediate sealing connecting plates may be made in a material chemically resistant selected from a plastic material, which can be typically selected from PTFE, PFA or PEEK material; or from a metal or alloy which can be typically selected from titanium, tantalum, or parts made in alloy like hastelloy, or titanium alloys, tantalum alloys, etc.

The disclosure also relates to the use of the microfluidic device for performing chemical reactions, sampling, analysis, etc. More generally, the disclosure relates to the use of the microfluidic device for performing any process that involves mixing, separation, extraction, crystallization, precipitation, or otherwise processing fluids or mixtures of fluids, including multiphase mixtures of fluids, including fluids or mixtures of fluids including multiphase mixtures of fluids that also contain solids, within a microstructure; said processing possibly including a physical process, a chemical reaction defined as a process that results in the interconversion of organic, inorganic, or both organic and inorganic species, a biochemical process, or any other form of processing.

### DESCRIPTION OF THE DRAWINGS

FIG. 1 is a 3-D view of a microfluidic device comprising a stacking of several glass, ceramic or glass ceramic, microfluidic modules, here four modules, provided, in this example, with two holding connectors 90 dedicated to thermal fluid inlets and outlets, here two inlets and two outlets on the left part of FIGS. 1 and 2, and with a holding connector 90 dedicated to reactant inlet and outlet on the right part of FIGS. 1 and 2.

FIG. 2 shows a cross-section of the microfluidic device showing more clearly the connectors system allowing stacking of several glass microfluidic modules.

FIG. 3 is an enlarged view of the holding connector 90 comprising a C-clamp structure.

FIG. 4 is another view of the holding connector showing more clearly the C-clamp structure without the presence of the micro fluidic modules.

FIG. 5 is another view of the holding connector, with a cross-section along the longitudinal axis wherein the C-clamp has the clamping means shown in cross section for better understanding the structure thereof.

FIG. 6 shows a 3D view of an intermediate sealing connecting plate according to a feature of the current disclosure, further provided with aligning means.

FIG. 7 shows a stacking of several glass microfluidic modules, comprising intermediate sealing connecting plates arranged between two successive microfluidic modules.

FIG. 8 shows a cross-section of an individual microfluidic module, wherein the feed inlet and the feed outlet are aligned, and wherein a microfluidic channel defining a microfluidic chamber is schematically shown.

FIG. 9 shows, in cross-section similar to FIG. 8, according to an exploded view for better understanding, a stacking of the microfluidic modules of FIG. 8, wherein intermediate sealing connecting plates are interposed between two successive individual micro fluidic modules, wherein the feed inlet(s) and the feed outlet(s) are aligned.

FIG. 10 shows, in a cross-section similar to FIG. 8, another embodiment of the microfluidic modules wherein the feed inlet and the feed outlet are offset;

FIG. 11 shows the stacking of offset inlet and outlet microfluidic modules of FIG. 10 with intermediate sealing connecting plates with also offset inlet(s) and outlet(s); and

FIG. 12 shows, in a cross-section, a conceptual view of the structure of the microfluidic module showing two thermal fluid layers with their thermal fluid channels sandwiching the treatment layer with its treatment channel, details of the inlets and outlets being not represented.

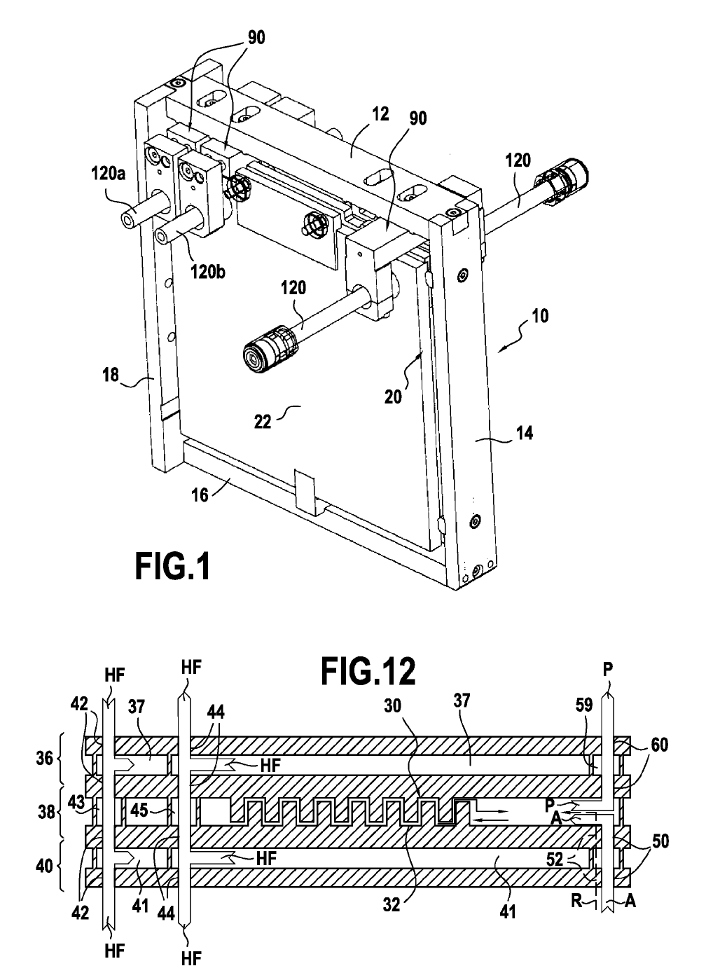

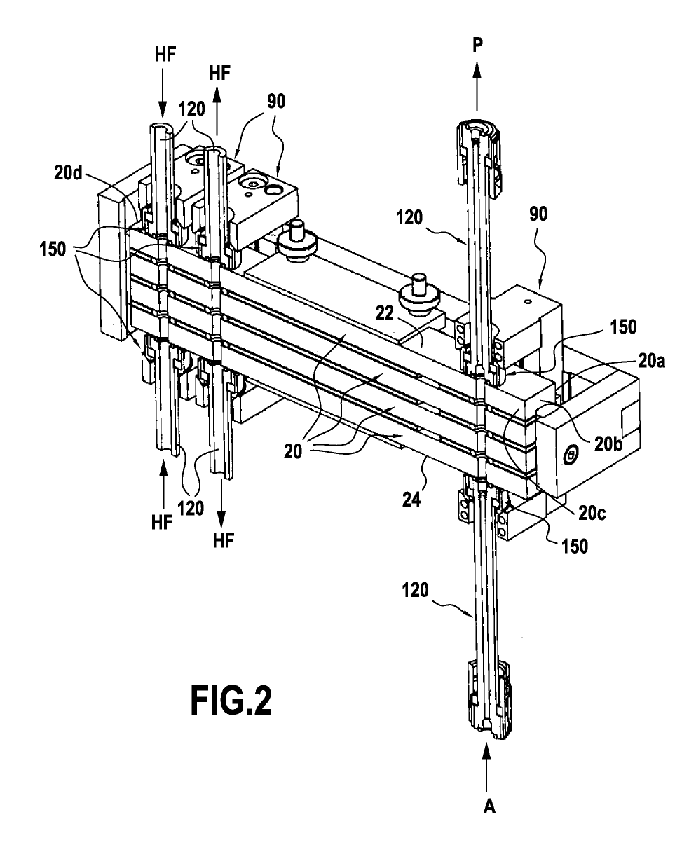

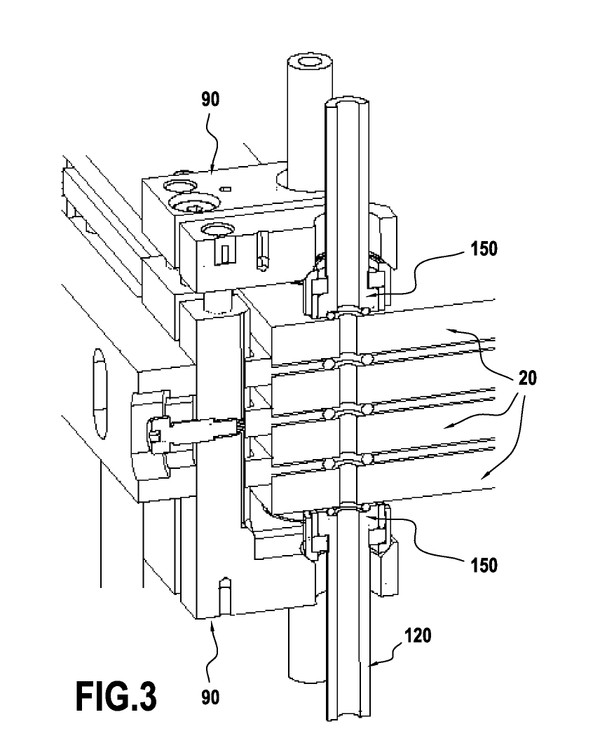

With reference to FIGS. 1 to 9, 11 and 12, it is shown a first embodiment of the present disclosure.

According to a first aspect, the present disclosure relates to a microfluidic device (10) including at least one, in this example four, glass, ceramic or glass ceramic, microfluidic module(s) (20) of substantially plate shape defining generally four relatively thin edges (20a, 20b, 20c, 20d) and two opposite relatively large faces (22,24). The microfluidic module could also be manufactured in a metal or an alloy, for example as described herebelow.

The microfluidic module(s) (20) is/are mounted on a frame member (12) comprising here also frame members (14, 16, 18).

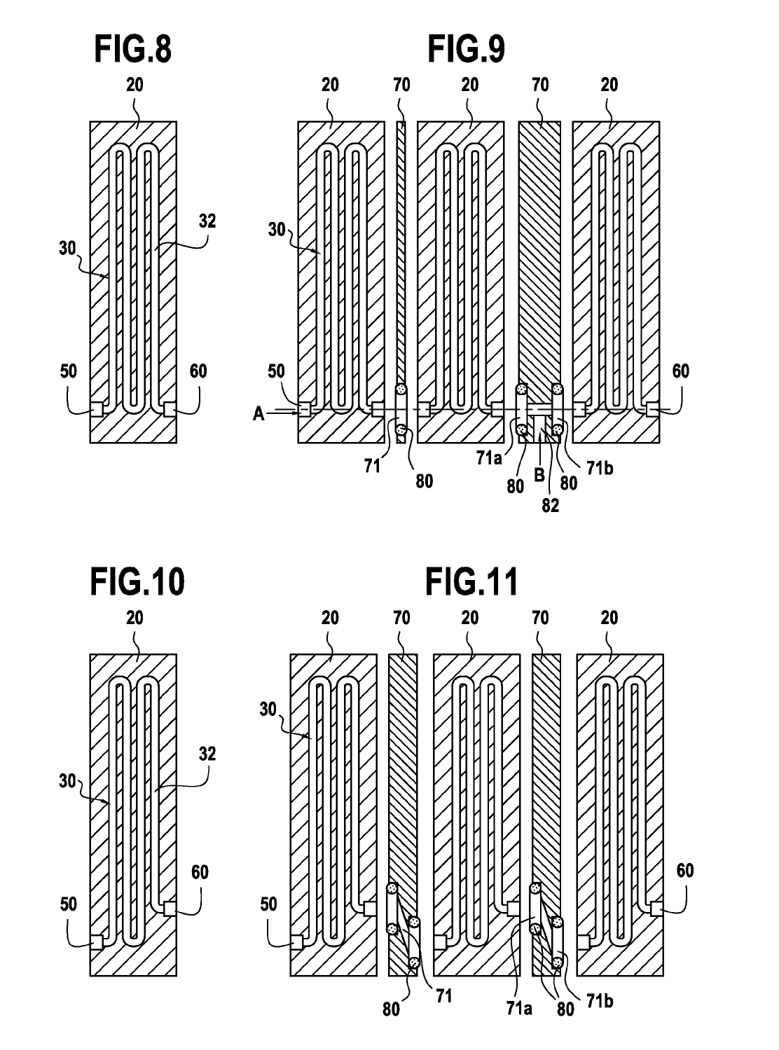

Each microfluidic module (20) includes at least one treatment layer (38) comprising at least one microfluidic channel (30) defining at least in part a microchamber (32); at least one microfluidic inlet (50) and at least one microfluidic outlet (60); see more particularly in a simplified representation for easy understanding on FIGS. 8 to 12.

Each microfluidic inlet (50) and each microfluidic outlet (60) of said microfluidic module is tightly interconnected with a fluid duct (120) through a tightly holding connector (90) comprising at least one, in particular at least one set of paired, clamping structures or clamping means (95, 97).

According to an aspect of the present disclosure, the microfluidic device is characterized in that said at least one clamping means (95, 97) comprises a joint (150) comprising a spherical shaped member (160) and a cup shaped member (170). This constitutes a type of “ball and socket” joint.

According to a particularly useful embodiment, the micro fluidic device comprises at least two stacked microfluidic modules, here four stacked modules, defining at least a set, here two sets, of two successive microfluidic modules tightly interconnected with a fluid duct (120) through at least one holding connector (90) which comprises a C-clamp defining a first lateral arm (94) with a first clamping means (95), a second lateral arm (96) with a second clamping means (97), and a main connecting part (92). This represents a very simple stacking structure.

According to a further embodiment, at least one of said first (94) and second (96) lateral arms is movable in translation relatively to said main connecting part as shown on FIGS. 1 to 5;

As shown on FIG. 12, each microfluidic module comprises for effectiveness of control of temperature in the microchamber (32), specific layers (36), (40) for thermal exchange with a heat regulated fluid (HF) on each side of the treatment layer (38) taken in <<sandwich>>.

Each micro fluidic module (20) is, in the shown embodiment, provided with at least 2 opposite thermal fluid inlets like (42) in communication with thermal fluid channels 37, 41 themselves in communication with two opposite thermal fluid outlets like (44). A specific path (43, 45) is of course foreseen during passage of the thermal fluid HF through the treatment layer (38) as is well understandable for one skill in the art.

The treatment layer (38) is here also provided with at least one fluid treatment feed inlet (50), for at least one fluid reactant (A) in communication with the treatment micro channel (30) defining the treatment chamber (32) themselves in communication with at least one fluid treatment feed outlet (60) for the exit of the treatment product (P), as shown on FIG. 12. A specific path (47) is of course foreseen during passage of the fluid reactant A through the thermal exchange layer (40) and a similar specific passage (49) for the fluid product (P) through the thermal exchange layer (36) as is well understandable for one skill in the art.

According to another feature of the present disclosure, it is further possible to foresee a fluid port or means (82) for injecting or extracting at least one fluid at an appropriate location of the stack; for example on at least one lateral edge of an intermediate sealing connecting plate (70) for injection of at least one further fluid reactant (R) in communication with the treatment microchannel (30), as shown in dotted lines on FIG. 12 as is well understandable for one skilled in the art.

The manufacture of the microfluidic modules (20), including the creation of appropriate microfluidic channel(s) (30) in the microfluidic modules (20) and the thermal fluid channels (37, 41) in the thermal exchange layers (36, 40) is well known to one skilled in the art. The prior art cited in the introductory part of the present application represents different ways of performing such a manufacture of such microfluidic channels. It can also be particularly referred to the full description of FR-2,830,206 B1 or to US 2003/0192587 A1, both of CORNING Inc.

The microfluidic device (10) has, according to a first inventive feature, at least one of the first and second clamping means (95, 97) which comprises a joint (150) itself comprising a spherical shaped member (160) and a cup shaped member (170), constituting a type of ball and socket joint, which will be described in detail later on.

According to another embodiment, the microfluidic device (10) is further characterized in that at least one of the first and second clamping means (95, 97) is provided with a radial retaining structure or anti-radial deformation means (180).

According to a specific feature, the anti-radial deformation means (180) comprises at least one metallic ring (182).

According to another specific feature, the spherical shaped member (160) is conformed to receive and support said anti-radial deformation means (180). In a particular embodiment, said spherical shaped member (160) may be integral to form a single piece with said anti-radial deformation means (180), which may have a ring shape.

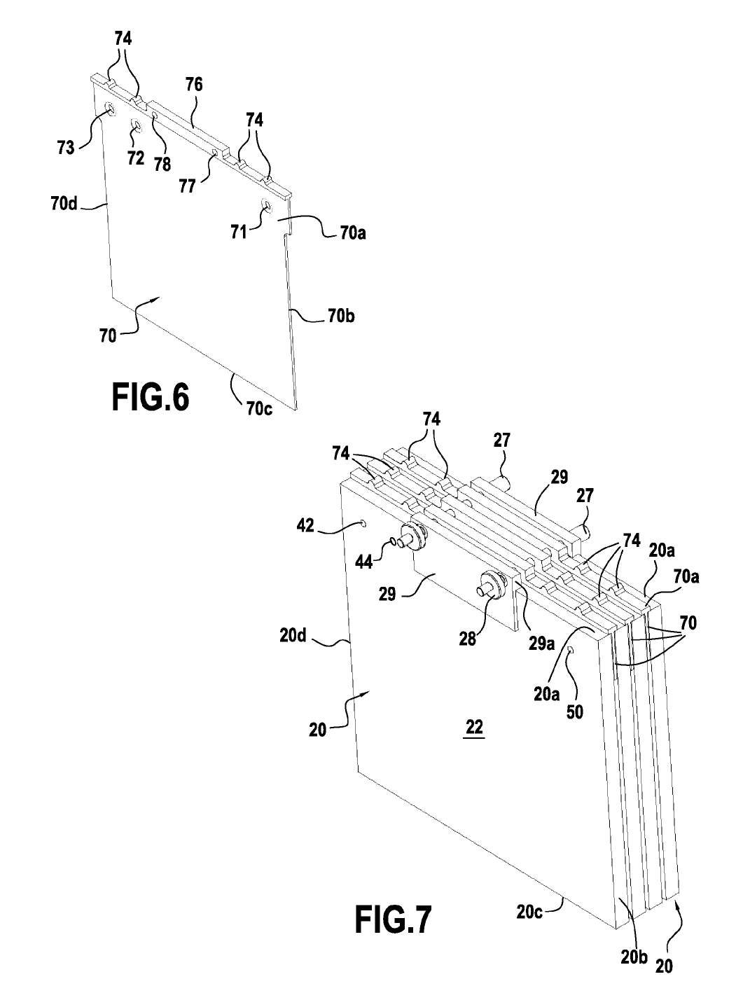

According to a further embodiment, the microfluidic device further includes between two successive microfluidic modules (20), an intermediate sealing connecting plate (70), see FIGS. 6 and 7, provided with through openings (71, 72, 73) adapted to match with adjacent fluidic inlets (50) and adjacent fluidic outlets (60), said connecting plate further comprising sealing structures or sealing means (80) on said through openings (71), clearly shown on cross-sections of FIGS. 8 to 11.

This intermediate sealing plate constitutes a significant alternative aspect of the present disclosure, further described below.

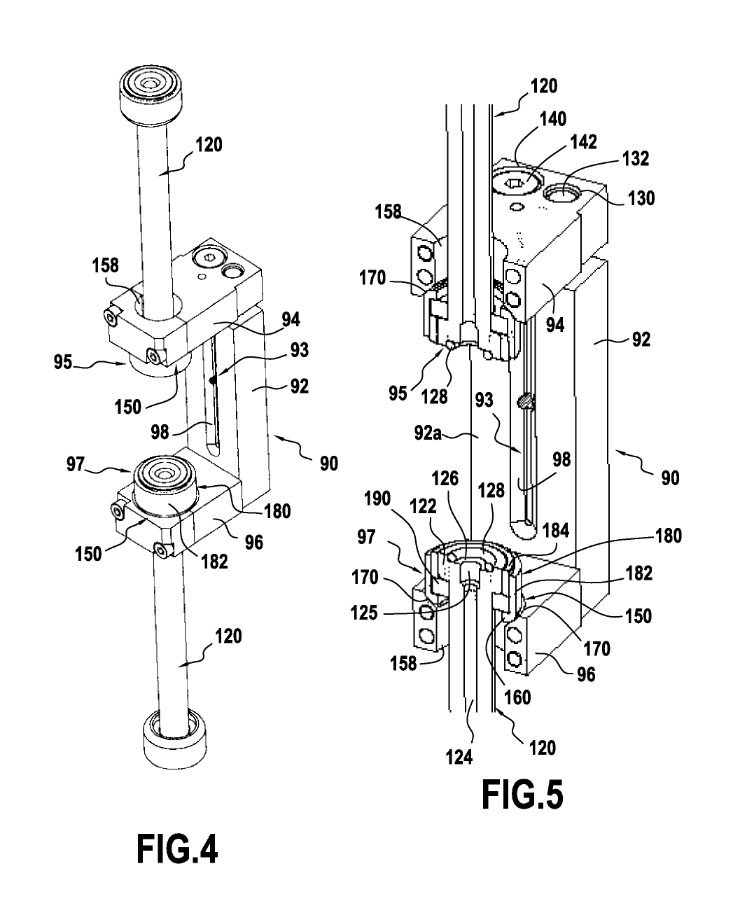

According to a particular feature, said intermediate connecting plate (70) comprises on at least one (70a) of said edges (70a, 70b, 70c, 70d), a first alignment structure or first aligning means (74), see FIGS. 6 and 7, adapted to cooperate with a second alignment structure or second aligning means (93), see FIGS. 4 and 5, provided on a corresponding edge (92a) of said holding connector (90), thereby ensuring easy proper alignment of said microfluidic modules. In this exemplified embodiment the first aligning means (74) comprise outside protruding pins cooperating with second alignment means (93) comprising a groove (98) to provide a proper alignment when the set of modules (20) with their intermediate connecting plates (70) are put in position between the arms of the connectors (90).

The connecting plates may have in particular a top lateral and central protruding part (76) provided with for instance two through holes (77,78), enabling to maintain together the microfluidic device defined by the combination of the modules (20) with their intermediate connecting plates (70) by insertion of rods (27) and screws (28) comprising holding plates (29) provided with a shoulder (29a) designed to contact top lateral edge (20a) of respective module (20). In a variant, said module (20) might also comprise a corresponding top lateral and central protruding part.

As it is shown on FIGS. 8 to 12, the microfluidic module (20) includes at least in part the microfluidic channel (30) defining at least in part the microchamber (32).

The fluid or feed A, FIG. 9, 12, to be treated in the microchamber (32) is of course flowing through each microfluidic module (20) from the feed inlet (50) through the microfluidic channel (30) to the microfluidic outlet (60) and from one microfluidic module (20) to the following one, as it is well understandable for one skilled in the art.

It is a specific feature of the present disclosure to provide intermediate sealing connecting plate(s) (70). The connecting plate(s) (70) is/are provided with through opening(s) (71, 72, 73) adapted to match with adjacent fluidic inlet(s) (50) and adjacent fluidic outlet(s) (60). For example, through opening (71) can be dedicated to reactant inlet and outlet whereas through openings (72, 73) can be dedicated to thermal fluid inlets and outlets.

Also, according to a particular feature, said connecting plate (70) further comprises sealing means (80) on said through openings (71, 72, 73) which can be located into specifically designed grooves like (71a), (71b), see FIGS. 9 and 11, to provide tightness in between the microfluidic modules (20).

This intermediate sealing connecting plate (70) can be made in a plastic material which can be typically selected from PTFE, PFA or PEEK material or in a metal or alloy as described further below.

According to the preferred embodiment shown on FIGS. 8 and 9, the microfluidic modules (20) have aligned and opposed inlet (50) and outlet (60) which is a more usual stacking configuration.

According to another embodiment shown on FIGS. 10 and 11, it is possible to provide a connection pattern wherein the inlet (50) and outlet (60) are opposed and offset, thereby having also corresponding offset inlet (71a) and outlet (71b) of the intermediate sealing connecting plate (70), as shown in these FIGS. 10 and 11.

It is understandable that when an offset configuration is desired, the use of the intermediate sealing connecting plate (70) provides the possibility to compensate easily this offset configuration.

In that case, the intermediate sealing connecting plate (70) is thicker, which is clearly shown on FIG. 11, as compared to FIG. 9, and in such a case, the inlet opening part (71a) and the outlet opening part (71b) are opposed and offset, with the intermediate opening (71) inclined, and each inlet (71a) and outlet (71b) is provided with a sealing means (80), usually a O-ring seal.

In the embodiment shown on FIG. 9, when it is necessary to inject or withdraw one fluid or feed B at an appropriate location of the stack, for instance in the middle of the stack, for example to introduce a further reactant or a further product or to withdraw it, at least one a specific feed B inlet or port means (82), may be foreseen on at least one lateral edge of an intermediate sealing connecting plate (70) which has a larger thickness as shown on FIG. 9 on the right part thereof.

Accordingly, the intermediate sealing connecting plate(s) (70) provide a much better versatility, with a simple and cost effective structure, for the manufacture of complex Microfluidic devices (10) adaptable to a number of industrial uses as well understandable for one of reasonable skill the art.

It is understandable for one of reasonable skill in the art that the material used for the O-ring seal located into the dedicated recesses of grooves are able to withhold internal pressure.

Further, the O-ring seals can be made in a polymer which is adapted to provide high chemical resistance like perfluoro-elastomer material like Kalrez®, Chemraz® or Perlast®.

Now, the specific structure of the joint (150) comprises a spherical shaped member (160) and a cup shaped member (170), and its mounting on the lateral arms (94) and (96) is described more particularly in relationship with FIGS. 4 and 5.

The first lateral arm (94) comprises a through orifice (158) which terminates at the inner part of the arm (94) with a bevelled enlargement which is aimed to constitute the cup shaped member (170) of the joint (150), see FIGS. 4 and 5. Similarly, the other arm (96) has the same structure in the present best embodiment with a through opening (158), a bevelled part here foreseen to constitute the cup shaped member (170).

The structure of the spherical shaped member (160) of the joint (150) is as follows:

The spherical shaped member 160) is linked to an outlet shouldered part (122) of a fluid duct (120) which comprises a central through orifice (124) terminating with an enlarged mouth end orifice (125) further provided with an annular recess (126) designed to receive an O-ring seal (128). The same structure applies in this example embodiment for all feed ducts (120) for each arm (94, 96) since they are identical.

Said a spherical shaped member (160) is provided by the lower part of an external piece (182) which here is foreseen to constitute an anti radial deformation means (180). Said external piece (182) is generally of a cylindrical structure having at the bottom part thereof an inwardly directed protrusion constituting the ball (102). This external piece (182) can in particular be made in a metal or an alloy, such as one cited here-below, as this will be understandable for one skilled in the art.

More generally, the connecting parts comprising the ball and socket joint (150), as well as the intermediate sealing connecting plates (70) can be made in a material chemically resistant selected from a plastic material, which can be typically selected from PTFE, PFA or PEEK material; or from a metal or alloy which can be typically selected from titanium, tantalum, or parts made in alloy like hastelloy, or titanium alloys, tantalum alloys.

Between the outlet shouldered part (122) of the fluid duct (120) and the anti-radial deformation means (180), an intermediate cylindrical ring (184) can be interposed which is providing an adapted contact with the glass, ceramic or glass ceramic material of the microfluidic modules. This intermediate ring (184) can be made of a hard plastic material like in PEEK.

According to the structure shown, the outlet shouldered part (122) of a fluid duct (120) can be supported on a specific horizontal annular ring (190) laying on the top inner surface of the spherical shaped member (160) and providing also a support surface for the intermediate ring (184).

According to a particular embodiment of the microfluidic device of the present disclosure, at this one of the lateral arms (94), (96) here the lateral arm (94) is movable into translation relatively to the main connecting part (92). This can be done in a very simple way. For instance, the lateral arm (94) comprises two through openings (130, 140), one through opening (130) being adapted to receive a guiding extension narrower part (132) of the main connection (92) which enables to guide the displacement into translation of the lateral arm (94) with regard to the main connecting part (92).

The second through opening (140) is adapted to receive a screw means (142) which can be screwed on a corresponding orifice foreseen in the main connecting part (92), not shown here since it is apparent for one skilled the art.

It is well understandable that with this spherical shaped member (160) and the cup shaped member (170) of the joint (150), it is possible to tightly connect the microfluidic devices (20) irrespective of the possible lack of perfect flatness of the surfaces of the microfluidic modules (20), thereby enabling less constraints in the manufacture of the glass, ceramic or glass ceramic pieces.

The structure as above described in reference to FIGS. 1 to 11, provides a much better stacking, therefore much better compactness, as compared to standard assembly within independent fluidic modules and single port connector for each inlet and outlet. As shown in FIGS. 1, 2, 5 and 7, stacking of 4 microfluidic modules has the same footprint as one single fluidic module.

The present disclosure or aspects thereof also provides a simplification and a reduction of number of connections.

Especially, due the fact that there are primarily only two inlets and two outlets for thermal fluid for 4 microfluidic modules stacked together instead of 8 required typically, the number of connections and piping is reduced.

The microfluidic device based on stacking microfluidic modules is simplified with less mechanics, namely frames, connectors, fittings, tubing, etc. or with tightness zones done with components not visible after assembly since the O-ring seals are located in between the microfluidic modules. Less mechanical pieces means further provide cost reduction and improve reliability reflects potential leakage zones.

The present disclosure or certain aspects thereof also provides for no internal volume without thermal control, in contrast with the typical single port feed duct as shown in the prior art, which can be made with PTFE adapter, PFA SWAGELOK© fittings has at least an internal volume of 0.5 ml which is not thermalized.

To avoid any risk of uncontrolled reaction into connection and piping, limiting this internal volume without any thermal control is significant. Typical stacking connection as shown in the present disclosure with only one O-ring seal in between the microfluidic modules avoids having volume without thermal control.

The present disclosure or certain aspects thereof also provides ease of assembly with self alignment principle. It is also important to reduce reactor assembly time for cost reductions. And beyond assembly time, it is critical to get tight assembly at the first mounting. It is well understandable that finding any leakage into the reactor can be a long and painful time.

The proposed stacking connection system according to one or more aspects of the present disclosure allows typically dividing by three mounting time and mechanical design while offering in another best embodiment a self alignment feature to be sure to get tight assembly.

As above described, a particularly significant alternative embodiment or feature of the present disclosure is provided by using specific intermediate sealing collecting plates (70) which are provided with first alignment means (74) designed to cooperate with corresponding second alignment means (93) providing on the corresponding edge (92a) of the main part (92) of the holding collector (90), thereby ensuring easy proper alignment of the microfluidic modules.

The methods of use and/or the devices disclosed herein are generally useful in performing any process that involves mixing, separation, extraction, crystallization, precipitation, or otherwise processing fluids or mixtures of fluids, including multiphase mixtures of fluids—and including fluids or mixtures of fluids including multiphase mixtures of fluids that also contain solids—within a microstructure. The processing may include a physical process, a chemical reaction defined as a process that results in the interconversion of organic, inorganic, or both organic and inorganic species, a biochemical process, or any other form of processing. The following non-limiting list of reactions may be performed with the disclosed methods and/or devices: oxidation; reduction; substitution; elimination; addition; ligand exchange; metal exchange; and ion exchange. More specifically, reactions of any of the following non-limiting list may be performed with the disclosed methods and/or devices: polymerisation; alkylation; dealkylation; nitration; peroxidation; sulfoxidation; epoxidation; ammoxidation; hydrogenation; dehydrogenation; organometallic reactions; precious metal chemistry/homogeneous catalyst reactions; carbonylation; thiocarbonylation; alkoxylation; halogenation; dehydrohalogenation; dehalogenation; hydroformylation; carboxylation; decarboxylation; amination; arylation; peptide coupling; aldol condensation; cyclocondensation; dehydrocyclization; esterification; amidation; heterocyclic synthesis; dehydration; alcoholysis; hydrolysis; ammonolysis; etherification; enzymatic synthesis; ketalization; saponification; isomerisation; quaternization; formylation; phase transfer reactions; silylations; nitrile synthesis; phosphorylation; ozonolysis; azide chemistry; metathesis; hydrosilylation; coupling reactions; and enzymatic reactions.

The embodiments shown in the FIGS. 1 to 12 are to be construed only as examples. Various changes of form, design, or arrangement may be made without departing from the spirit and scope of the invention that is defined by the following claims.

1. A microfluidic device (10) including at least one glass, ceramic or glass ceramic microfluidic modules (20) of substantially plate shape defining generally four relatively thin edges (20a, 20b, 20c, 20d) and two opposite relatively large faces (22,24), each microfluidic module (20) including at least one microfluidic channel (30) defining at least in part a microchamber (32); at least one microfluidic inlet (50) and at least one microfluidic outlet (60); and each microfluidic inlet (50) and each microfluidic outlet (60) of said microfluidic module being tightly interconnected with a fluid duct (120) through a tightly holding connector (90) comprising at least one clamping structure or means (95, 97), wherein said at least one clamping structure or means (95, 97) comprises a joint (150) comprising a spherical shaped member (160) and a cup shaped member (170).

2. The microfluidic device of claim 1, wherein the at least one clamping means (95, 97) is provided with an anti-radial deformation structure or means (180).

3. The microfluidic device of claim 2, wherein the anti-radial deformation means (180) comprises at least one metallic ring (182).

4. The microfluidic device of claim 2, wherein the spherical shaped member (160) is conformed to receive and support said anti-radial deformation means (180).

5. The microfluidic device of claim 1, comprising at least two stacked microfluidic modules defining at least a set of two successive microfluidic modules tightly interconnected with a fluid duct (120) through at least one holding connector (90) comprising a C-clamp defining a first lateral arm (94) with a first clamping means (95), a second lateral arm (96) with a second clamping means (97) and a main connecting part (92).

6. The microfluidic device of claim 5, wherein at least one of said first and second lateral arms (94, 96) is movable into translation relatively to said main connecting part (92);

7. The microfluidic device of claim 5, further including between two successive microfluidic modules (20), an intermediate sealing connecting plate (70) provided with through openings (71, 72, 73) adapted to match with adjacent fluidic inlets (50) and adjacent fluidic outlets (60), said connecting plate further comprising sealing means (80) on said through openings (71, 72, 73).

8. The microfluidic device of claim 1, comprising fluid port or means (82) for injecting or extracting at least one fluid at an appropriate location of the stack, for example on at least one lateral edge of an intermediate sealing connecting plate (70) for injection of at least one further fluid reactant (R) in communication with the treatment microchannel (30); or for extracting a part of the fluid.

9. The microfluidic device of claim 1, wherein the microfluidic modules (20) have aligned and opposed inlets (50) and outlets (60).

10. The microfluidic device of claim 1, comprising a connection pattern wherein the inlets (50) and outlets (60) are opposed and offset, thereby having also corresponding offset opposed inlets (71a) and outlets (71b) of the intermediate sealing connecting plates (70).

11. The microfluidic device of claim 7, wherein said intermediate connecting plate (70) comprises on at least one of said edges (70a, 70b, 70c, 70d), first aligning means (74) adapted to cooperate with second aligning means (93) provided on a corresponding edge (92a) of said holding connector (90) thereby ensuring easy proper alignment of said microfluidic modules.

12. The microfluidic device of claim 1, wherein the connecting parts comprising the joint (150), as well as the intermediate sealing connecting plates (70) are made in a material chemically resistant selected from a plastic material, which can be typically selected from PTFE, PFA or PEEK material; or from a metal or alloy which can be typically selected from titanium, tantalum, or parts made in alloy like hastelloy, or titanium alloys, tantalum alloys.

13. The microfluidic device of claim 1, wherein the microfluidic modules comprise specific layers (36, 40) for thermal exchange on each side of the treatment layer (38) taken in <<sandwich>>, each microfluidic module (20) being provided with 2 opposite thermal fluid inlets (42) and two opposite thermal fluid outlets (44), whereas the treatment layer (38) is provided with at least one fluid feed inlet (50) and at least one fluid feed outlet (60).

14. Use of the microfluidic device as defined in claim 1, for performing any process that involves mixing, separation, extraction, crystallization, precipitation, or otherwise processing fluids or mixtures of fluids, including multiphase mixtures of fluids, including fluids or mixtures of fluids including multiphase mixtures of fluids that also contain solids, within a microstructure; said processing possibly including a physical process, a chemical reaction defined as a process that results in the interconversion of organic, inorganic, or both organic and inorganic species, a biochemical process, or any other form of processing.
